(19) United States
(12) Patent Application Publication
(10) Pub. No.: US 2025/0334348 A1
(43) Pub. Date: Oct. 30, 2025

(54) Heat Exchanger with Reservoir, in Particular for a Thermal Management Module

(71) Applicant: MAHLE International GmbH, Stuttgart (DE)

(72) Inventors: Michael Schmidt, Bietigheim-Bissingen (DE); Dominik Behnert, Leonberg (DE); Gustavo Fuga Santos, Gerlingen (DE)

(21) Appl. No.: 19/188,677

(22) Filed: Apr. 24, 2025

(30) Foreign Application Priority Data
Apr. 29, 2024 (DE) 102024111895.4

(51) Int. Cl. F28D 20/00

(52) U.S. Cl. CPC F28D 20/0034

(57) ABSTRACT

A heat exchanger for a thermal management module in a motor vehicle is provided, containing numerous plates, a first flow path for a coolant, a second flow path for a refrigerant, and a reservoir for separating gaseous and liquid portions of the refrigerant and/or collecting and storing the refrigerant, wherein the plates are stacked or adjacent to one another such that channels are formed between adjacent plates, wherein a first part of the channels belongs to the first flow path, wherein a second part of the channels belongs to the second flow path, wherein the second flow path has a first section for heating and condensing the vaporized refrigerant, wherein the second flow path has a second section for supercooling the condensed refrigerant. The refrigerant flows from the first section into the second section through the reservoir. The plates each have at least six holes, wherein at least four connecting elements, which form the fluid intakes and fluid outlets for the second flow path, are on the same end of the stack of plates forming the heat exchanger, while a fluid channel for the second flow path is formed on the opposite end of the stack of plates, wherein another connecting element, forming a fluid intake for the reservoir, is connected to the first section, wherein a second connecting element, forming a fluid outlet for the reservoir, is connected to the second section.

### CROSS-REFERENCE TO RELATED APPLICATIONS

This application claims priority from German Patent Application No. DE 10 2024 111 895.4, filed Apr. 29, 2024, the entirety of which is hereby incorporated by reference herein.

The invention relates to a heat exchanger, composed of plates and containing two flow paths, with a reservoir, in particular for a thermal management module.

DE 10 2012 217 090 A1 discloses a heat exchanger (condenser) with which a refrigerant can be condensed for storage purposes and to further cool it. This heat exchanger (condenser) contains plates (stacked together), a first flow path for a refrigerant, and a second flow path for a coolant. There are numerous plates that are stacked to form channels between them, a first part of which belong to the first flow path and a second part of which belong to the second flow path. The first flow path contains a first section for cooling and condensing the refrigerant, and a second section for supercooling the condensed refrigerant, with a reservoir for storing refrigerant through which the refrigerant passes when flowing from the first section to the second. The reservoir is connected to the first section by a first element that forms a fluid intake for the reservoir, and to the second section by a second element that forms a fluid outlet for the reservoir. The first and second connecting elements are tubes that pass through numerous holes in the plates. Fluid can flow through second flow path, and the second flow path has a fluid intake and outlet at the same end of the stack. The reservoir is connected to the disclosed heat exchanger. The reservoir is brazed to one end of the stack. The reservoir contains a cylinder. The connecting elements for the fluid intake and outlet in the two flow paths for the coolant and refrigerant are on opposite ends of the stack. A motor vehicle body defines the installation space available for all of the systems and components of the vehicle. Because the number of systems and components continues to increase, the space available for the disclosed heat exchanger with a reservoir is diminishing. Unfortunately, the disclosed heat exchanger cannot fit with its reservoir in the available installation space. This heat exchanger, with its reservoir, is often combined with other components such as an expansion valve and compressor to obtain a thermal management module. If there is not enough available installation space for the heat exchanger and reservoir, they must be separated from one another. This requires more refrigerant and coolant lines. Consequently, this increases the size and weight of the heat exchanger, reservoir and connecting lines. Moreover, because the connecting elements for the fluid intake and outlet are at opposite ends of the stack of plates, the connecting lines have to be longer, or there has to be more than one tube passing through the stack.

The device obtained with the invention, which has the features of the independent claim, has the advantage that the heat exchanger and reservoir are separated and at least four connecting elements for the fluid intakes and outlets for the two flow paths are on the same end of the stack of plates.

The basis for the invention is a heat exchanger with a reservoir, containing stacked or adjacent plates. This heat exchanger or thermal management module can be used in a refrigerant and/or coolant circuit in a motor vehicle. The motor vehicle can contain an at least partially electric drive. The heat exchanger obtained with the invention, in particular for a thermal management module in a motor vehicle, contains numerous plates, a first flow path for a coolant, a second flow path for a refrigerant, and a reservoir for separating gaseous and liquid portions of the refrigerant, and/or for collecting and storing the refrigerant. The two flow paths are separate, and allow for heat exchange between the coolant and the refrigerant. The coolant can contain glycol, and the refrigerant can be R1234yf, carbon dioxide (R744), or propane (R290). The plates are rectangular and most of them have the same size and shape. They can have longer sides and shorter sides, or they can be square. Only the outer plates and those within the stack that have an additional purpose, such as diverting or blocking the fluid in a flow path, have a different shape. These plates may be made of metal, e.g. aluminum alloy. The edges of the plates can be bent upward. The plates can be stacked or adjacent to one another, forming channels between them. A hollow chamber is formed between each pair of adjacent plates. The plates can have structured surfaces. These structures increase the surface area of the plates available for heat exchange. They also partition the hollow chambers between two plates into the channels. Fluid flowing through the channels may exhibit turbulence, thus benefitting the heat exchange between two fluids. Connecting points may be formed on these structures and the edges of the plates. These points are where the plates are connected to one another, e.g. with a bonding process. The plates are stacked or placed next to one another to form channels between them. A first part of these channels belongs to the first flow path. A second part of the channels belongs to the second flow path. The second flow path contains a first section for heating and condensing the refrigerant. The second flow path contains a second section for supercooling the condensed refrigerant. The refrigerant flows from the first section to the second through the reservoir. Each of the plates have at least six holes, and at least four connecting elements, which form the fluid intakes and outlets for the second flow path, are at the same end of the stack of plates forming the heat exchanger, while a fluid channel for the second flow path is placed at the other end of the stack, and another connecting element, which forms a fluid intake for the reservoir, is connected to the first section, while another connecting element, which forms a fluid outlet for the reservoir, is connected to the second section. The plates forming the heat exchanger obtained with the invention can each contain holes that have a rim, a passage, or a dome, and holes without a rim, passage, or dome. Consequently, the hollow chambers and channels between two adjacent plates can separate or connect the two hollow chambers and two flow paths. If two adjacent plates have holes with a rim, passage, or dome, the fluid flows into the hollow chamber downstream of the next hollow chamber, or a channel is formed that conducts the fluid through this section of the heat exchanger obtained with the invention. “Separated” in terms of fluid exchange means that no, or only a negligible amount of, fluid can pass through the connection. The stack of plates is understood to mean the plates that are stacked or placed next to one another when the heat exchanger obtained with the invention is assembled.

By way of example, a refrigerant circuit for a motor vehicle can contain the following components: a heat exchanger obtained with the invention, which has a reservoir forming an indirect condenser for a refrigerant, an expansion valve for the refrigerant, a vaporizer for the refrigerant, a compressor for the refrigerant, and connecting lines. The refrigerant circuit can be part of an air conditioner or heater. Refrigerant flows through the refrigerant circuit. R1234yf could conceivably flow through the refrigerant circuit, for example. Alternatively, carbon dioxide (R744), propane (R290) or R134a could also flow through the refrigerant circuit. The heat exchanger obtained with the invention, which has a reservoir, expansion valve, and compressor, can be incorporated in a thermal management module. The vaporizer can be used to remove heat from the interior of a motor vehicle, which is then delivered through the heat exchanger to a coolant, in that a refrigerant is condensed and cooled in the heat exchanger obtained with the invention. The reservoir improves the efficiency of the refrigerant circuit in various environmental conditions by storing refrigerant, which is then released as needed. The reservoir can be structured such that the phases of the refrigerant, i.e. gaseous and liquid, are separated by gravity. These different environmental conditions can be the different seasons of the year, for example. Because the refrigerant circuit is closed, and only contains one reservoir, the refrigerant circuit is self-regulating. A high pressure section of the refrigerant circuit can be obtained in the form of an indirect condenser, and a low pressure section can be obtained with the vaporizer. The refrigerant is significantly more pressurized in the high pressure section than in the low pressure section. The reservoir can be placed in the high pressure section such that the refrigerant that has already flowed through a first section of the heat exchanger flows through it. The vaporized refrigerant may not be entirely liquified in the first section of the heat exchanger through the pressurized cooling, and thus still contain vaporized portions. By placing the reservoir downstream of the first section of the heat exchanger, it can be ensured that only fully liquified refrigerant can exit the reservoir. The refrigerant exiting the reservoir is cooled further in the second section of the heat exchanger obtained with the invention. By supercooling the refrigerant, bubbles are eliminated therein prior to entering the expansion valve, thus preventing damage thereto, and ensuring that the refrigerant circuit functions properly. The extent of supercooling necessary to ensure proper operation depends on the design, pressure losses in the refrigerant circuit, and the vertical distance between the condenser and the vaporizer. If the refrigerant is supercooled to a greater extent, the efficiency of the refrigerant circuit can be further increased.

The coolant is distributed to and retrieved from the hollow chambers and channels through two of the at least six holes in the plates. The refrigerant is conducted through the heat exchanger obtained with the invention through the remaining holes in the plates. By subdividing the first flow path into a first section, in which the gaseous refrigerant is condensed, and a second section, in which the condensed refrigerant is supercooled, it is ensured that fully supercooled refrigerant always exits the heat exchanger obtained with the invention. This heat exchanger must contain at least six connecting elements: two for the fluid intake and outlet for the coolant, two for the fluid intake and outlet for the refrigerant, and two connecting the reservoir to the second flow path for the refrigerant. The second section, for supercooling the refrigerant, is above the first section, in which the refrigerant is condensed, in the stack of plates. The plates must contain at least six holes. Because of this, the refrigerant must first flow through the first section, and then from the reservoir through the second section. This is obtained with two of the at least six holes. The coolant and refrigerant are then conducted to and retrieved from the hollow chambers and channels in the second section through the other four holes. To simplify production, a type of plate that has six holes is used. Unneeded holes in the plates can be blocked. This advantageously results in a heat exchanger that has two sections, which has the connecting elements for the fluid intake and outlet for a refrigerant at one end of the stack, and the connecting elements for the fluid intake and outlet of a coolant at the other end. The heat exchanger obtained with the invention contains a fluid channel that is part of the second flow path for the refrigerant. Consequently, the direction in which the refrigerant flows in the first section can be reversed at least once, preferably twice, along the vertical axis, and returned along the side of the heat exchanger. This results in a U-shaped flow path for the refrigerant through the stack. The ends of the stack can be formed by at least one plate and a cover plate.

The reservoir and heat exchanger are separated and/or spaced apart in the invention. This advantageously reduces the structural height of the heat exchanger and reservoir in the stacking direction. The structural height is substantially determined by the height of the stack of plates and/or the diameter of the reservoir.

In a first embodiment of the heat exchanger, the heat exchanger and reservoir can be separated. By way of example, the heat exchanger and reservoir can each be connected to a mounting plate or distributor plate. This distributor plate can contain the channels for the fluids.

In a second embodiment, the heat exchanger and reservoir can be spaced apart. By way of example, the heat exchanger and reservoir can be connected to a distributor plate. The distributor plate can contain channels for the fluids.

A preferred exemplary embodiment is characterized in that two additional connecting elements, which form the fluid intake and outlet for the first flow path, and the four connecting elements that form the fluid intakes and outlets for the second flow path, are all on the same end of the stack of plates forming the heat exchanger obtained with the invention. This results in three differently shaped paths for the coolant and refrigerant in the two flow paths: first, coolant and refrigerant can be conducted in opposite directions through the flow paths such that they flow past one another in opposite directions. Ideally, the temperatures of the fluids are exchanged such that the colder fluid reaches the same temperature as the hotter fluid and vice versa. Second, coolant and refrigerant can be conducted through the two flow paths in the same direction, such that they flow next to one another in the same direction. Ideally, the temperatures of the two fluids equalize, and remain between the two initial temperatures. Third, coolant and refrigerant can cross through the two flow paths. This is between first two configurations. Combinations thereof are also conceivable, which complement the advantages thereof.

In a particularly beneficial development of the invention, the two other connecting elements, forming the fluid intake and outlet for the first flow path, and the four connecting elements forming the fluid intakes and outlets for the second flow path, can be on opposite ends of the stack of plates forming the heat exchanger. The guide channel can be on the same end as the two connecting elements forming the fluid intake and outlet for the first flow path. This simplifies the configuration of lines for the coolant circuit and refrigerant circuit.

In a particularly beneficial development of the invention, the fluid channel can be connected to just one of the four connecting elements forming the fluid intakes and outlets for the second flow path. This allows for the refrigerant to be conducted to the reservoir from the second section through the first section by the fluid channel. This further improves the performance of the heat exchanger with a reservoir that is obtained with the invention. Each of the plates can have six holes, at least two of which can be surrounded by a dome. The domes can separate the two flow paths from one another.

A preferred exemplary embodiment is characterized in that the direction in which refrigerant flows in the first section is reversed at least once through the heat exchanger along the vertical axis. This results in a U-shaped path for the refrigerant. This advantageously further improves the performance of the heat exchanger, such that a greater amount of refrigerant can be cooled and condensed in the first section. The direction in which the refrigerant flows may be reversed vertically numerous times in the first section, thus further improving the performance of the heat exchanger obtained with the invention.

In a particularly beneficial development of the invention, the heat exchanger can contain at least one separating plate or separating plane. The at least one separating plane can have one hole fewer than the plates. By way of example, if each of the plates has six holes, the at least one separating plate can contain five holes. It is possible to first form the plates, and then the holes. Consequently, a separating plate can then be produced with one less hole. This allows for the direction in which fluid flows to be reversed vertically, or to separate the first and second sections. Instead of a separating plate, a separating plane can be placed in a hole. This separating plate or plane can block or divert channels in the two flow paths. The main advantage with this structure, composed of stacked or adjacent plates, is that most of the plates have the same size and shape, with only the cover plates and separating plates differing therefrom. This results in a simple and inexpensive production.

It may also be advantageous if fluid can flow through the second flow path serially and/or in parallel. The refrigerant flows through the second flow path. Further advantages can be obtained if coolant can flow through the first flow path serially or in parallel. This can further improve heat exchange between the refrigerant and the coolant.

The flow paths also preferably have first channels and last channels, through which the coolant and refrigerant flow in opposite directions. This further increases the heat exchange between the coolant and refrigerant, thus further improving the performance of the heat exchanger obtained with the invention.

The heat exchanger obtained with the invention is preferably an indirect condenser. Heat can be transferred to a fluid, e.g. a coolant, in an indirect condenser by condensing the refrigerant with the coolant. By way of example, an indirect condenser can be used to condense the refrigerant in a thermal management module for an air conditioner in a motor vehicle. Building the indirect condenser from stacked or adjacent plates results in an efficient heat exchanger that can be produced inexpensively.

The reservoir preferably contains at least two cylinders. These cylinders are substantially parallel to one another. The cylinders can be tubes that are closed with caps at the ends. By dividing the volume needed to separate the gaseous and liquid portions of the refrigerant and/or collect and store the refrigerant into two cylinders, the structural height of the reservoir can be advantageously reduced, thus reducing the installation space necessary for the heat exchanger with a reservoir obtained with the invention. The reservoir can be made of a metal such as aluminum. The two cylinders can be produced in an extrusion process, and the caps can be bonded thereto. The at least two cylinders are connected to one another for fluid exchange. The reservoir has two connecting elements for fluid intake and outlet with which it is connected to the heat exchanger for fluid exchange. The reservoir advantageously increases the efficiency of the refrigerant circuit in different environmental conditions by storing refrigerant that is released as needed. The various environmental conditions can be the different seasons of the year. The term “substantially” indicates angular deviation of ±10° and/or length deviation of ±1 mm.

In a particularly beneficial development of the invention, the reservoir can contain a cylinder. This cylinder can be formed by a tube that is closed at both ends with caps. The gaseous and liquid portions of the refrigerant can be separated from one another and/or the refrigerant can be collected and stored in the reservoir. The reservoir can be made of a metal such as aluminum, for example. The cylinder can be produced in an extrusion process and the caps can be bonded to the cylinder. The reservoir has two connection elements for the fluid intake and outlet with which the reservoir is connected to the heat exchanger. The reservoir advantageously increases the efficiency of the refrigerant circuit in different environmental conditions by storing refrigerant and releasing it as needed. The different environmental conditions can be the different seasons of the year, for example.

With the invention, the thermal management module for a motor vehicle contains at least one compressor or pump, at least one expansion valve, and at least one heat exchanger with a reservoir obtained with the invention. The heat exchanger with a reservoir is one of those described above. The heat exchanger can be an indirect condenser. The heat exchanger and reservoir are separated from one another. The thermal management module obtained with the invention can be used in a motor vehicle with an at least partially electric drive. The body of the vehicle defines the available installation space for all of the systems and components of a motor vehicle. Various thermal circuits for the vehicle can be combined in the thermal management module obtained with the invention. These can include the coolant circuit for the batteries, the coolant circuit for the electric drive, the refrigerant circuit for the air conditioning of the interior and the refrigerant circuit for a heat pump. By combining the thermal circuits in the thermal management module obtained with the invention, the efficiency of the motor vehicle can be increased by reducing the energy needed to heat and cool that would otherwise be obtained from the battery. This can take place for example by combining a coolant circuit for the battery and a refrigerant circuit for a heat pump. Furthermore, the need for lines for the refrigerant and/or coolant can be reduced through the integration of components in the thermal management module. This reduces the installation space needed for the module and the weight thereof. The amount of coolant and/or refrigerant can be reduced. The heat exchanger and reservoir obtained with the invention are separated from one another, thus further reducing the installation space needed for the module. The installation of the thermal management module can be simplified by the integration. The thermal management module can contain other components, e.g. bidirectional valves, 3-way valves, another heat exchanger (e.g. a chiller), and a control unit. The thermal management module obtained with the invention can be used in a refrigerant circuit and/or a coolant circuit.

In a first exemplary embodiment, the thermal management module obtained with the invention can contain a compressor, an expansion valve, and a heat exchanger with a reservoir obtained with the invention.

In a second exemplary embodiment, the thermal management module obtained with the invention can contain a compressor, an expansion valve, a heat exchanger with a reservoir obtained with the invention, a pump, and another heat exchanger.

With the invention, the refrigerant circuit and/or coolant circuit have at least one thermal management module obtained with the invention. In a first use of the invention, this thermal management module can be used in a coolant circuit for a motor vehicle. The motor vehicle can have an at least partially electric drive. The coolant circuit can have a heat source, such as a battery, and a coolant can flow through it. The pump, expansion valve, and heat exchanger obtained with the invention are integrated in the thermal management module. The heat exchanger can be used as an indirect condenser. The coolant can be condensed in the heat exchanger by another fluid. The coolant can be carbon dioxide (R774) for example, and the other fluid can be a mixture of water and glycol. The pump generates a pressure that conveys the coolant from the heat source to the heat exchanger and back. The expansion valve regulates the pressure and the temperature of the coolant circulating through the coolant circuit. By integrating the pump, expansion valve, and heat exchanger in the thermal management module, the need for lines for the coolant in the coolant circuit can be advantageously reduced, and by integrating the components in a module, the installation space can be reduced.

In a second use of the invention, the thermal management module obtained with the invention can be used in a refrigerant circuit in a motor vehicle. The motor vehicle can have an at least partially electric drive. The refrigerant circuit can be part of a heat pump system. In a motor vehicle with an at least partially electric drive, the energy for heating the interior must be obtained from the battery. This reduces the potential travel range of the motor vehicle. The heat needed to heat the interior can be obtained from the environment with a heat pump system, thus increasing the travel range of the motor vehicle. A heat pump system can be composed of three parts: a heat source, which draws heat from the environment, at least one heat pump that contains the refrigerant circuit obtained with the invention, and at least one heat consumer, which distributes the heat in a motor vehicle, for example, in order to heat the interior or the battery. The heat source can be air. A refrigerant, e.g. carbon dioxide (R744) or propane (R245) can flow through the refrigerant circuit. Heat can be obtained from the air using a heat exchanger in the form of a direct vaporizer with which the refrigerant is vaporized. The thermal management module obtained with the invention can contain a compressor, an expansion valve, and a heat exchanger with a reservoir obtained with the invention. The refrigerant can be condensed in the heat exchanger, and the heat can be transferred to another fluid. The heat exchanger can thus be operated as an indirect condenser. The refrigerant can be condensed in the compressor, thus increasing the pressure thereof, which can then be relieved again in the expansion valve. The gaseous refrigerant can be overheated in the second section of the first flow path in the heat exchanger obtained with the invention, such that any remaining liquid portions can be vaporized. This prevents liquid portions of the refrigerant from entering the compressor, thus improving the performance of the refrigerant circuit. This is because more power can be transferred. The liquid refrigerant can be further supercooled, thus condensing any remaining gaseous portions. This prevents gaseous portions from entering the expansion valve. By integrating the compressor, expansion valve and heat exchanger obtained with the invention in the thermal management module, the need for lines for the refrigerant in the refrigerant circuit can be reduced, and the necessary installation space can be reduced by integrating the components in a module.

In a third use of the invention, the thermal management module obtained with the invention can be used in a coolant circuit and a refrigerant circuit for a motor vehicle with an at least partially electric drive. The coolant circuit can contain at least one heat source, e.g. a battery, and coolant can flow through it. The pump, expansion valve, and heat exchanger obtained with the invention are integrated in the thermal management module. With motor vehicles that have an at least partially electric drive, the battery and the electric motor must be kept at a constant temperature to obtain the longest possible service life and optimal performance. At high ambient temperatures, the cooler (indirect condenser) in the coolant circuit may not be powerful enough. In this case, an additional heat exchanger can be integrated in the thermal management module. The first flow path in the heat exchanger obtained with the invention can be incorporated in the coolant circuit, and the second flow path can be incorporated in the refrigerant circuit. Because the refrigerant is colder, the coolant can be cooled to where the battery and motor can be kept at a constant temperature. The other heat exchanger is thus used as a chiller. By integrating the pump, expansion valve, heat exchanger obtained with the invention, and other heat exchanger in the thermal management module, the need for lines for the coolant in the coolant circuit and for the refrigerant in the refrigerant circuit can be reduced, and by integrating the components in a module, the necessary installation space can be reduced. A coolant composed of a mixture of water and glycol can flow through the coolant circuit. A refrigerant can flow through the refrigerant circuit. This refrigerant can be carbon dioxide (R744) or propane (R245).

In the drawings:

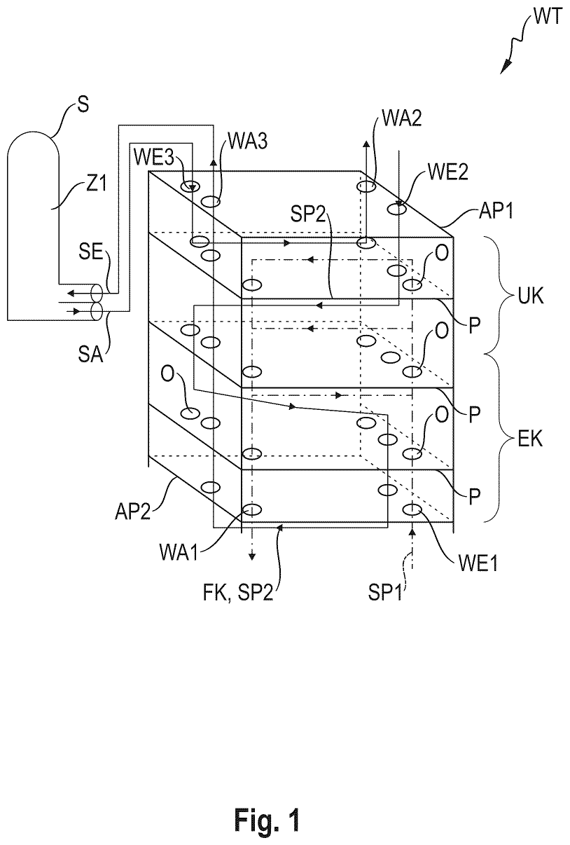

FIG. 1 shows a schematic view of the heat exchanger with a reservoir obtained with the invention, with which a refrigerant can be condensed, stored and supercooled, wherein the reservoir and heat exchanger are separated from one another;

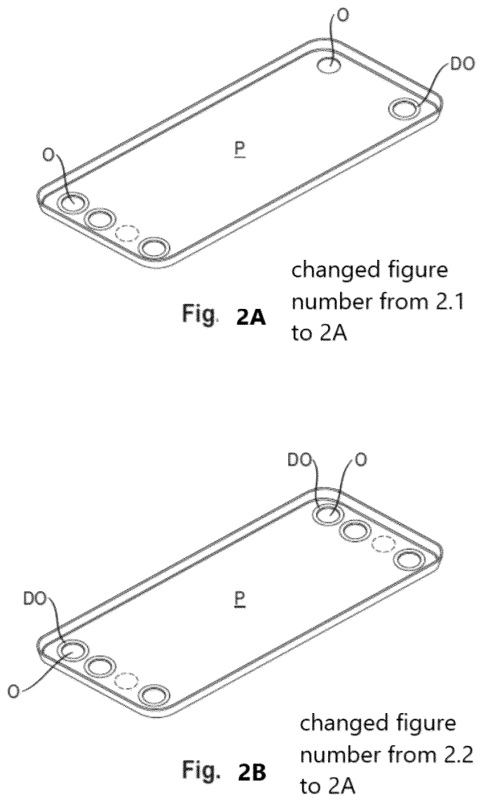

FIG. 2A shows a plate obtained with the invention, from above;

FIG. 2B shows another plate obtained with the invention, from above; and

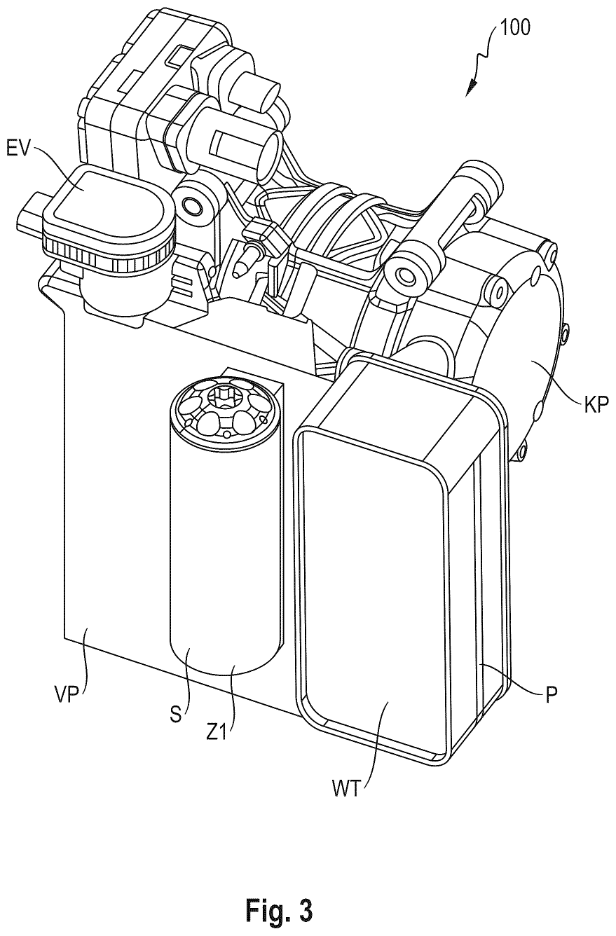

FIG. 3 shows a first embodiment of the thermal management module obtained with the invention, from above.

A schematic view of a first embodiment of the heat exchanger WT with a reservoir S obtained with the invention is shown in FIG. 1. This heat exchanger WT with a reservoir S can be used in a thermal management module (not shown) for a refrigerant circuit and/or coolant circuit in a motor vehicle. The heat exchanger WT is composed of numerous stacked plates P. The plates P are basically the same size and shape, and only the cover plates AD1, AD2 on the ends of the stack and separating plates (not shown) within the stack differ therefrom. The plates in the heat exchanger obtained with the invention are made of metal, e.g. an aluminum alloy, and are bonded together in a brazing process. This results in a simple and inexpensive production process.

The heat exchanger WT with a reservoir S is schematically illustrated in FIG. 1. The individual parts of the heat exchanger WT, e.g. the first section EK and second section UK, are simply shown as block elements in FIG. 1. Each of these elements is really composed of numerous plates P. Each plate P has six holes O. By arranging the holes with domes appropriately, channels (not shown) are formed by adjacent plates. A first part of the channels belongs to the first flow path SP1, and a second part belongs to the second flow path SP2. These first and second parts can alternate in the stack. A coolant flows through the first flow path SP1, which is schematically indicated by a broken line. The coolant can be a mixture of water and glycol. A refrigerant flows through the second flow path SP2, which is schematically indicated by a solid line. The refrigerant can be R1234yf or carbon dioxide (R774). This drawing illustrates how the coolant and refrigerant are supposed to flow through the heat exchanger WT with a reservoir S obtained with the invention. The second flow path SP2 in the heat exchanger WT is composed of a first section EK and a second section UK. The liquid refrigerant is vaporized in the first section EK. Transferring heat from the coolant to the refrigerant heats the refrigerant. The coolant also flows through the first section WK in the first flow path SP1. The direction in which the refrigerant flows is reversed once in the first section EK along the vertical axis of the heat exchanger WK. The second section UK is above the first section WK. The liquid refrigerant is further cooled by the coolant in the second section UK. The coolant also flows through the second section in the first flow path SP1. The reservoir S is adjacent to and separate from the heat exchanger WT. The refrigerant flows through the first section EK and subsequently through the second section UK. The direction in which the refrigerant flows is reversed along the vertical axis (in a U-shape) in the first section EK. This improves the performance of the heat exchanger WK obtained with the invention. The reservoir S is also shown schematically, and contains a cylinder Z1. The reservoir S can be made of a metal, e.g. an aluminum alloy. The refrigerant S flows through the reservoir S. A filter can be placed in the reservoir S for filtering the refrigerant, and/or a desiccant can be placed in the reservoir S to remove moisture from the refrigerant. The reservoir is used to separate gaseous portions of the refrigerant from liquid portions, and/or collect and store the refrigerant. The two fluid intakes WE2, WE3, and the two fluid outlets WA2, WA3 are at one end (the upper end) of the stack of plates in the heat exchanger WK obtained with the invention. The fluid intake WE1 and fluid outlet WA1 for the coolant are on opposite ends of the stack of plates. The channel FK forming the second flow path is located at this lower end of the stack. The refrigerant can be returned in this channel FK, in which the direction in which the refrigerant flows is reversed twice along the vertical axis of the heat exchanger obtained with the invention. By this means, and by separating the heat exchanger WK and the reservoir S, a compact assembly is obtained. The coolant is supplied and removed through the first fluid intake WE1 and first fluid outlet WA1, flowing in parallel through the first section WK and second section UK. The refrigerant is supplied to the first section EK through the second fluid intake WE2, and removed through the second fluid outlet WA2 and then conveyed into the reservoir through the fluid intake SE therein. By way of example, the refrigerant can flow through the second section UK into the first section EK through two holes surrounded by domes. The refrigerant exits the reservoir S through the fluid outlet SA therein, and flows into the second section UK of the heat exchanger WK through the fluid intake WA3. The refrigerant then exits the second section UK through the third fluid intake WA3.

A second embodiment of a plate P obtained with the invention is shown in FIGS. 2A and 2B. The plate P is rectangular, with short sides and long sides. The edge of the plate P is raised over the entire periphery thereof. The plate P can have surface structures (not shown), which increase the surface area available for heat transfer. These structures can form the first part of the channels between the plates that belongs to the first flow path (not shown), and the second part of the channels that belongs to the second flow path (not shown). The plates P each have at least six holes O. Some of these holes O can be surrounded by a dome DO. Four of these holes O are on one of the shorter sides.

A first embodiment of a plate P is shown from above in FIG. 2A. The plate P has six holes O. Four of these holes O are on one of the short sides, and two are on the other.

A second embodiment of a plate P is shown from above in FIG. 2B. This plate P has eight holes O. There are four holes on each of the short sides. This results in a symmetrical arrangement of holes in the plate. At least two of these holes O are surrounded by a dome DO.

FIG. 3 shows a first embodiment of a thermal management module 100 obtained with the invention. The thermal management module contains a heat exchanger WT with a reservoir obtained with the invention (e.g. the first embodiment thereof), a compressor KP and an expansion valve EP. The reservoir S is separated from the heat exchanger WT. The reservoir S is spaced apart from the heat exchanger WT. The compressor KP, expansion valve EV, heat exchanger WT, and reservoir are connected to a distributor plate VP. The distributor plate VP contains the necessary channels (not shown) for connecting the components. The thermal management module 100 shown in FIG. 3 can be part of a refrigerant circuit (not shown) for a motor vehicle. A refrigerant (not shown) can be condensed in the heat exchanger WT, and the heat therefrom can be transferred to another fluid (not shown). The heat exchanger WT can thus be used as an indirect condenser. A refrigerant (not shown) can be condensed in the compressor, thus increasing the pressure thereof, and this pressure can then be relieved in the expansion valve. The refrigerant can be stored in the reservoir S, which is substantially formed by the cylinder Z1. By integrating the compressor KP, expansion valve WV and heat exchanger WT with a reservoir S obtained with the invention in the thermal management module 100 obtained with the invention, lines for the refrigerant can be advantageously eliminated in the refrigerant circuit, and by integrating the components in a module, the necessary installation space can be reduced. Because the reservoir S and heat exchanger WT are separated, the height of the thermal management module 100 can be advantageously reduced, making better use of the available installation space in the body of a motor vehicle.

The specification can be readily understood with reference to the following Numbered Paragraphs:
Numbered Paragraph 1. A heat exchanger (WK), in particular for a thermal management module (100) in a motor vehicle, containing:
   numerous plates (P)
   a first flow path (SP1) for a coolant
   a second flow path (SP2) for a refrigerant
   a reservoir (S) for separating gaseous and liquid portions of the refrigerant, and/or collecting and storing the refrigerant,
   wherein the plates (P) are stacked or adjacent to one another such that channels are formed between adjacent plates (P)
   wherein a first part of the channels belongs to the first flow path (SP1)
   wherein a second part of the channels belongs to the second flow path (SP2)
   wherein the second flow path (SP2) has a first section (EK) for heating and condensing the vaporized refrigerant
   wherein the second flow path (SP2) has a second section (UK) for supercooling the condensed refrigerant
   wherein the refrigerant flows from the first section (EK) into the second section (UK) through the reservoir (S)
   characterized in that the plates (P) each have at least six holes (O), wherein at least four connecting elements, which form the fluid intakes (ZL2, ZL3) and fluid outlets (AL2, AL3) for the second flow path (SP2), are on the same end of the stack of plates forming the heat exchanger (WK), while a fluid channel (FK) for the second flow path (SP2) is formed on the opposite end of the stack of plates, wherein a first connecting element, forming a fluid intake (SE) for the reservoir (S), is connected to the first section (EK), wherein a second connecting element, forming a fluid outlet (SA) for the reservoir (S), is connected to the second section (UK).
Numbered Paragraph 2. The heat exchange (WK) according to Numbered Paragraph 1, characterized in that the reservoir (S) and heat exchanger (WK) are separated from one another and/or spaced apart from one another.
Numbered Paragraph 3. The heat exchanger (WK) according to Numbered Paragraph 1 or 2, characterized in that the two other connecting elements, which form the fluid intake (ZL1) and fluid outlet (AL2) for the first flow path (SP1), and the four connecting elements that form the fluid intakes (ZL2, ZL3) and fluid outlets (AL2, AL3) for the second flow path (SP2), are all on the same end of the stack of plates forming the heat exchanger (WK).
Numbered Paragraph 4. The heat exchanger (WK) according to Numbered Paragraph 1 or 2, characterized in that two other connecting elements, which form the fluid intake (SP1E1) and fluid outlet (SP1A1) for the first flow path (SP1), and the four connecting elements that form the fluid intakes (ZL2, ZL3) and fluid outlets (AL2, AL3) for the second flow path (SP2), are on opposite ends of the stack of plates forming the heat exchanger (WK).
Numbered Paragraph 5. The heat exchanger (WK) according to Numbered Paragraph 3 or 4, characterized in that the fluid channel (FK) is only connected to one of the four connecting elements forming the fluid intakes (ZL2, ZL3) and fluid outlets (AL2, AL3) for the second flow path (SP2).
Numbered Paragraph 6. The heat exchanger (WK) according to Numbered Paragraph 3, 4, or 5, characterized in that the direction in which the refrigerant flows in the first section (EK) is reversed at least once along the vertical axis of the heat exchanger (WK).
Numbered Paragraph 7. The heat exchanger (WK) according to any of the preceding Numbered Paragraphs, characterized in that the heat exchanger (WK) contains at least one separating plate (TP) or one separating plane (TE).
Numbered Paragraph 8. The heat exchanger (WK) according to any of the preceding Numbered Paragraphs, characterized in that a fluid can flow serially through the second flow path (SP2).
Numbered Paragraph 9. The heat exchanger (WK) according to any of the preceding Numbered Paragraphs, characterized in that heat exchanger (WK) is an indirect condenser.
Numbered Paragraph 10. The heat exchanger (WK) according to any of the preceding Numbered Paragraphs, characterized in that the reservoir (S) contains at least two cylinders (Z1, Z2), wherein the at least two cylinders (Z1, Z2) are substantially parallel to one another, wherein the at least two cylinders (Z1, Z2) are connected to one another for fluid exchange.
Numbered Paragraph 11. The heat exchanger (WK) according to at least one of the Numbered Paragraphs 1 to 9, characterized in that the reservoir (S) contains a cylinder (Z1).
Numbered Paragraph 12. A thermal management module (100) for a motor vehicle that contains at least one compressor (KP) or pump (PU), at least one expansion valve (EV), and at least one heat exchanger (WK) with a reservoir (S) according to at least one of the Numbered Paragraphs 1 to 11.
Numbered Paragraph 13. A refrigerant circuit and/or coolant circuit for a motor vehicle that contains at least one thermal management module (100) according to Numbered Paragraph 12.

### LIST OF REFERENCE SYMBOLS

WT heat exchanger obtained with the invention
P plates forming the heat exchanger obtained with the invention
O holes in the plates
DO dome surrounding a hole
VP distribution plate
TP separating plate
TE separating plane
FK Fluid channel
SP1, SP2 flow paths for a coolant and a refrigerant
AP1, AP2 cover plates for the heat exchanger obtained with the invention
EK first section for cooling and condensing the vaporized refrigerant
UK second section for supercooling the condensed refrigerant
WE1, WE2, WE3 fluid intakes for flow paths in the heat exchanger obtained with the invention
WA1, WA2, WA3 fluid outlets for the flow paths in the heat exchanger obtained with the invention
S reservoir for separating gaseous and liquid portions of the refrigerant from one another, and/or for collecting and storing the refrigerant
SE fluid intake in the reservoir
SA fluid outlet in the reservoir
Z1, Z2 cylinders in the reservoir
100 thermal management module obtained with the invention
KP compressor
PU pump
EV expansion valve

1-13. (canceled)

14. A heat exchanger, in particular for a thermal management module in a motor vehicle, containing:
a plurality of plates;
a first flow path (SP1) configured for a coolant to flow therethrough;
a second flow path (SP2) configured for a refrigerant to flow therethrough;
a reservoir configured for separating gaseous and liquid portions of the refrigerant, and/or configured for collecting and storing the refrigerant;
wherein the plurality of plates are stacked or adjacent to one another such that channels are formed between adjacent plates of the plurality of plates;
wherein a first part of the channels establishes a portion of the first flow path (SP1);
wherein a second part of the channels establishes a portion of the second flow path (SP2);
wherein the second flow path (SP2) comprises a first section configured for heating and condensing the gaseous portions of the refrigerant
wherein the second flow path (SP2) comprises a second section configured for supercooling the liquid portions of the refrigerant
wherein the refrigerant flows from the first section into the second section through the reservoir;
wherein the plurality of plates each have at least six holes and at least four connecting elements that form the fluid intakes (ZL2, ZL3) and fluid outlets (AL2, AL3) for the second flow path (SP2) that are on a same end of the stack of the plurality of plates forming the heat exchanger, wherein a fluid channel (FK) for the second flow path (SP2) is formed on an opposite end of the stack of the plurality of plates as the fluid intakes, further comprising a first connecting element that forms a fluid intake (SE) for the reservoir and is connected to the first section, and further comprising a second connecting element that forms a fluid outlet (SA) for the reservoir that is connected to the second section.

15. The heat exchange according to claim 14, wherein the reservoir and heat exchanger are separated from one another and/or spaced apart from one another.

16. The heat exchanger according to claim 14, wherein the first and second connecting elements that form the fluid intake (ZL1) and fluid outlet (AL2) for the first flow path (SP1), and the four connecting elements that form the fluid intakes (ZL2, ZL3) and fluid outlets (AL2, AL3) for the second flow path (SP2), are all on a same end of the stack of the plurality plates forming the heat exchanger.

17. The heat exchanger according to claim 14, wherein the first and second connecting elements that form the fluid intake (SP1E1) and fluid outlet (SP1A1) for the first flow path (SP1), and the four connecting elements that form the fluid intakes (ZL2, ZL3) and fluid outlets (AL2, AL3) for the second flow path (SP2), are each on opposite ends of the stack of the plurality of plates forming the heat exchanger.

18. The heat exchanger according to claim 16, wherein the fluid channel (FK) is only connected to one of the four connecting elements forming the fluid intakes (ZL2, ZL3) and fluid outlets (AL2, AL3) for the second flow path (SP2).

19. The heat exchanger according to claim 16, wherein a direction in which the refrigerant flows in the first section is reversed at least once along the vertical axis of the heat exchanger.

20. The heat exchanger according to claim 14, wherein the heat exchanger comprises at least one separating plate or at least one separating plane.

21. The heat exchanger according to claim 14, wherein a fluid can flow serially through the second flow path (SP2).

22. The heat exchanger according to claim 14, wherein heat exchanger is an indirect condenser.

23. The heat exchanger according to claim 14, wherein the reservoir comprises at least two cylinders, wherein the at least two cylinders are substantially parallel to one another, wherein the at least two cylinders are connected to one another for fluid exchange.

24. The heat exchanger according to claim 14, wherein the reservoir comprises a cylinder.

25. A thermal management module for a motor vehicle that comprises at least one compressor or pump, at least one expansion valve, and at least one heat exchanger with a reservoir according to claim 14.

26. A refrigerant circuit and/or coolant circuit for a motor vehicle that comprises at least one thermal management module according to claim 25.
